(19) United States
(12) Patent Application Publication
(10) Pub. No.: US 2005/0097475 A1
(43) Pub. Date: May 5, 2005

(54) Image comparative display method, image comparative display apparatus, and computer-readable medium

(75) Inventors: Katsuya Makioka, Saitama (JP); Masakazu Nishijima, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/937,776

(22) Filed: Sep. 10, 2004

(30) Foreign Application Priority Data
Sep. 12, 2003 (JP) P.2003-321043

(51) Int. Cl. G06F 3/00

(52) U.S. Cl. 715/792; 715/781; 715/788; 715/838

(57) ABSTRACT

An image comparative display method having displaying two images; that is, a first image and a second image, on a monitor screen in a side-by-side arrangement, wherein the first image is selected by a first set of images, and the second image is selected by a second set of images, wherein the monitor screen is split into a first region that displays the first image; a second region that displays the second image; a third region adjacent to the first region, the third region displaying at least one first thumbnail image corresponding to at least one image from the first set of images; and a fourth region adjacent to the second region, the fourth region displaying at least one second thumbnail image corresponding to at least one image from the second set of images.

### BACKGROUND OF THE INVENTION

1. Field of the Invention

The present invention relates to a comparative method for displaying two images side by side on a monitor screen, and more particularly, to a comparative display method, an image comparative display apparatus, and computer-readable medium having instructions which enable an easy operation for selecting two images to be compared and a comparison operation.

2. Description of the Related Art

A digital camera has come into widespread use. A plurality of photographed images are taken into a personal computer or the like, and the thus-captured data is preserved in a mass-storage medium, such as a hard disk drive. Moreover, each image is subjected to trimming on a monitor screen of the personal computer or subjected to image processing through use of retouching software or the like. The thus-processed images are also preserved along with the captured images.

Meanwhile, as a large number of images are accumulated, it becomes harder to select favorite images from the thus-accumulated images. Therefore, for example, according to a related-art technique described in JP-A-2000-298467 provided below, a monitor screen is split in two, thereby enabling side-by-side display of two images. The two images are compared with each other on the monitor screen, thereby enabling easy visual determination of a difference between the images.

As described in JP-A-2000-298467, the monitor screen is split in two, and images are displayed on the thus-split screens, thereby enabling accurate comparison of the images. However, when an attempt is made to change one of the images to another image, the related-art technique described in JP-A-2000-298467 encounters a problem of the impossibility of ascertaining an overview of another image before the current image is changed to that image.

According to the related-art technique described in JP-A-2000-298467, a sync display button for the purpose of synchronization is provided. Images displayed on the respective two split screens are synchronously subjected to enlargement, reduction, scrolling (activation of the sync display button), separate enlargement, separate reduction, and separate scrolling (deactivation of the sync display button). However, difficulty will be encountered in ascertaining which one of the screens the current operating status pertains to, unless an operator operates the sync display button.

### SUMMARY OF THE INVENTION

An object of the present invention is to provide an image comparative display method and an image comparative display apparatus and a computer-readable medium containing instructions for performing the method, which provide an easy operation to select images to be compared and enable rendering of an easy determination as to whether or not synchronous operation is performed.

According to the invention, there is provided a method of comparatively displaying a first image and second image, comprising: displaying said first image and said second image on a user interface in a side-by-side arrangement, wherein the first image is selected from a first set of images and the second image is selected from a second set of images, wherein the user interface includes a first region that displays the first image; a second region that displays the second image; a third region adjacent to the first region, the third region displaying at least one first thumbnail image corresponding to at least one image from the first set of images; and a fourth region adjacent to the second region, the fourth region displaying at least one second thumbnail image corresponding to at least one image from the second set of images.

Further, according to the invention, there is provided a computer-readable medium including set of instructions for comparatively displaying a plurality of images, said set of instructions comprising: dividing a user interface into a first region that displays a first image; a second region that displays a second image; a third region adjacent to the first region, the third region displaying at least one first thumbnail image corresponding to at least one image from a first set of images; and a fourth region adjacent to the second region, the fourth region displaying at least one second thumbnail image corresponding to at least one image from a second set of images; and displaying the first image and the second image, on a user interface in a side-by-side arrangement, wherein the first image is selected from the first set of images and the second image is selected from the second set of images.

Furthermore, according to the invention, there is provided a comparative image display apparatus comprising: a display device comprising a user interface; a display control section that controls a screen display on the monitor screen by executing said set of instructions in the computer-readable medium, said instructions comprising, dividing the user interface into a first region that displays a first image; a second region that displays a second image; a third region adjacent to the first region, the third region displaying at least one first thumbnail image corresponding to at least one image from a first set of images; and a fourth region adjacent to the second region, the fourth region displaying at least one second thumbnail image corresponding to at least one image from a second set of images; and displaying the first image and the second image, on a user interface in a side-by-side arrangement, wherein the first image is selected from the first set of images and the second image is selected from the second set of images; and an input device by way of which a plurality of operation buttons displayed on the user interface are operated.

By means of this configuration, selection of a first image to be displayed in the first region and selection of a second image to be displayed in the second region are facilitated.

In the image comparative display method, the image comparative apparatus and the computer-readable medium, all pertaining to the present invention, at least one first operation button to be used for performing at least one operation for the first image is displayed outside a first image display frame of the first region, at least one second operation button to be used for performing at least one operation for the second image, the second operation button being different from the first operation button, is displayed outside a second image display frame of the second region; and a sync button which is to be used for setting whether or not the first and second images are operated synchronously and for canceling the setting is provided between said at least one first operation button and said at least one second operation button.

By means of this configuration, an operation for the first image and an operation for the second image can be performed separately, and the operator can readily identify which one of the operations is being performed.

In the image comparative display method, the image comparative apparatus and the computer-readable medium, all pertaining to the present invention, when, as a result of selection of the sync button, the first and second images are brought into a state in which first and second images are operated synchronously, said at lease one first operation button and said at least one second operation button are displayed in an integrated manner.

By means of this configuration, the number of operation buttons provided around an image is reduced, and operation is facilitated. Further, the operator can also readily determine that the images are in a sync status.

In the image comparative display method, the image comparative apparatus and the computer-readable medium, all pertaining to the present invention, each of said at least one first operation button and said at least one second operation button includes at least one of an enlargement/reduction operation button, a display region shift operation button, a display image rotating operation button, and a display image color area warning display operation button.

By means of this configuration, common operation buttons for image operation are prepared, and respective operations become easy.

In the image comparative display method, the image comparative apparatus and the computer-readable medium, all pertaining to the present invention, the use interface displays a command button to be used for switching a screen display by selecting one from a first screen layout and a second screen layout, wherein the first screen layout comprises the first and second regions being arranged horizontally on the use interface, the third region being arranged below the first region, and the fourth region being arranged below the second region; and the second screen layout comprises the first and second regions being arranged vertically on the use interface, the third region being arranged on the right of the first region, and the fourth region being arranged on the right of the second region.

By means of this configuration, the user can compare images by means of selecting a desired screen layout.

In the image comparative display method, the image comparative apparatus and the computer-readable medium, all pertaining to the present invention, a magnification of the first image is displayed in the first region, and a magnification of the second image is displayed in the second region.

By means of this configuration, the user can perform an operation for comparing images by reference to a magnification.

In the image comparative display method, the image comparative apparatus and the computer-readable medium, all pertaining to the present invention, a display status of the second image displayed in the second region is not changed when the first image is changed to another first image by selecting and displaying one of said at least one first thumbnail image in the third region.

By means of this configuration, a second image which is used as a source for comparison is fixed, and a first image which is an object of comparison can be changed to another image. Thus, the number of operations pertaining to the image used as a source for comparison can be reduced.

In the image comparative display method, the image comparative apparatus and the computer-readable medium, all pertaining to the present invention, when an operation is performed while the user interface includes the first region, the second region, the third region and the fourth region, a fifth region is opened in the user interface and a tree structure of folders is displayed in the fifth region.

By means of this configuration, selection of folders storing images desired to be displayed becomes easy.

In the image comparative display method, the image comparative apparatus and the computer-readable medium, all pertaining to the present invention, when another operation is performed while the user interface includes the first region, the second region, the third region, the fourth region, and the fifth region, the fifth region is closed.

By means of this configuration, when the tree structure displayed in the fifth region become unnecessary, the fifth region is closed by means of this configuration, thereby enabling use of a wide screen.

In the image comparative display method, the image comparative apparatus and the computer-readable medium, all pertaining to the present invention, when a first folder is selected from the tree structure while selecting the first region, said at least one first thumbnail image corresponding to at least one image included in the first folder is displayed in the third region; and when a second folder is selected from the tree structure while selecting the second region, said at least second thumbnail image corresponding to at least one image included in the second folder is displayed in the fourth region, wherein the first and second folders are one of same and different.

By means of this configuration, the fifth region where the tree structure is to be displayed can be shared between the first region and the second region, thereby enabling use of a wide screen.

In the image comparative display method, the image comparative apparatus and the computer-readable medium, all pertaining to the present invention, a first mark representing a selected first region state and a second mark representing a selected second region state are displayed in a first region corner and a second region corner, respectively.

By means of this configuration, it is possible to readily determine whether or not an image of the folder selected by means of the displayed tree structure is displayed in the first region or the second region.

In the image comparative display method, the image comparative apparatus and the computer-readable medium, all pertaining to the present intention, when at least one bookmark is affixed to at least one of the first image and second images, at least one thumbnail image corresponding to at least one of the bookmarked first and second images is displayed and affixed with a mark image representing the bookmark in at least one of (i) said at least one first thumbnail image displayed in the third region and (ii) said at least one second thumbnail image displayed in the fourth region.

This configuration enables ascertainment of the presence/absence of the bookmark by means of looking in a thumbnail image.

In the image comparative display method, the image comparative apparatus and the computer-readable medium, all pertaining to the present invention, said at least bookmark comprises a plurality of types of bookmarks, and a corresponding plurality of mark images, each of which represents each of said plurality of types of bookmarks, are displayed in colors according to the types of the plurality of bookmarks.

This configuration enables easy determination of a selected state of the image by means of presence/absence of various types of bookmarks. Further, an image can be distinguished from the other images by means of the type of the bookmark.

In the image comparative display method, the image comparative apparatus and the computer-readable medium, all pertaining to the present invention, when at least one of (i) said at least one first thumbnail image and (ii) said at least one second thumbnail image is displayed, at least one RAW thumbnail image corresponding to a RAW data image is displayed while being affixed with a RAW data indicator.

This configuration enables rendering of a determination as to whether or not image data are RAW data, by means of glancing at the thumbnail image.

In the image comparative display method, the image comparative apparatus and the computer-readable medium, all pertaining to the present invention, a first operation button configured to change a display size of said at least one first thumbnail image and a second operation button configured to change a display size of said at least one second thumbnail image are displayed outside respective image display frames of the third and fourth display regions.

This configuration enables effective utilization of screen ranges of the third and fourth regions.

In the image comparative display method, the image comparative apparatus and the computer-readable medium, all pertaining to the present invention, a first operation window configured to change a sequence in which said first thumbnail images are to be sorted and a second operation window configured to change a sequence in which said at least second thumbnail images are to be sorted are displayed outside of image display frames of the third and fourth regions, respectively.

This configuration enables an easy change in a sequence in which thumbnail images are to be displayed.

### BRIEF DESCRIPTION OF THE DRAWINGS

FIG. 1 is a block diagram of an image comparative display apparatus according to an exemplary embodiment of the present invention;

FIG. 2 is a layout drawing of an image comparative display screen according to the exemplary embodiment of the present invention;

FIG. 3 is an enlarged view of an area encircled by a circle III shown in FIG. 2;

FIG. 4 is a view showing a modified layout of the screen shown in FIG. 2;

FIG. 5 is an enlarged view of operation buttons shown in FIG. 2;

FIG. 6 is a view of integrated operation buttons shown in FIG. 5;

FIG. 7 is a view of operation buttons pertaining to a thumbnail image;

FIG. 8 is an enlarged view of an area encircled by a circle VIII shown in FIG. 2;

FIG. 9 is a screen view in which a tree structure display region is opened;

FIG. 10 is a view showing an example tree structure;

FIG. 11A is a view showing an example lamp image in an illuminated state; and

FIG. 11B is a view showing an example lamp image in an unilluminated state.

### DETAILED DESCRIPTION OF THE INVENTION

An embodiment of the present invention will hereinafter be explained with reference to the accompanying drawings.

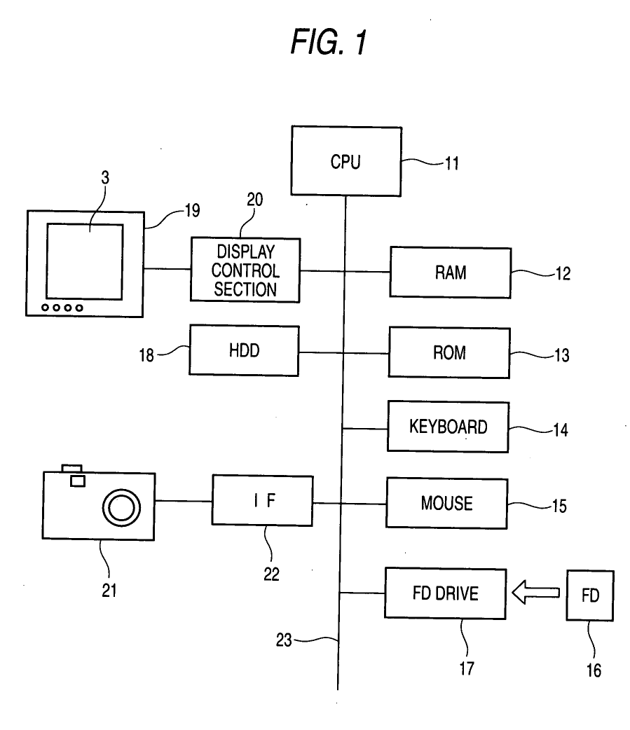

FIG. 1 is a block diagram of an image comparative display apparatus according to an embodiment of the present invention. This image comparative display apparatus is realized by executing a set of instructions in a computer-readable medium for performing the methods of the present invention. In more detail, the image comparative display apparatus can be embodied by installing an image comparative display program corresponding to the set of instructions on a general purpose or specific purpose computing device (e.g., personal computer) or the like.

The image comparative display apparatus of the present embodiment comprises a high-speed central processing unit (CPU) 11; random access memory (RAM) 12 serving as main memory; read-only memory (ROM) 13 for storing initial programs or the like; a keyboard 14 serving as an input device; a pointing device 15 such as a mouse (hereinafter referred to a “mouse”); an FD drive 17 to which an external storage medium, such as a flexible disk 16, is connected; a hard disk drive (HDD) 18 serving as a mass storage medium; a display control section 20 to which is connected a monitor display device 19 having a monitor screen 3 (i.e., a user interface); an interface (IF) section 22 to be used for connecting a digital camera 21; and a bus 23 for interconnecting these elements. However, the input device that performs the function of operating various operation buttons displayed on the monitor screen is not limited to the keyboard 14 or the pointing device 15, and may also include other input user interfaces that are well-known in the art.

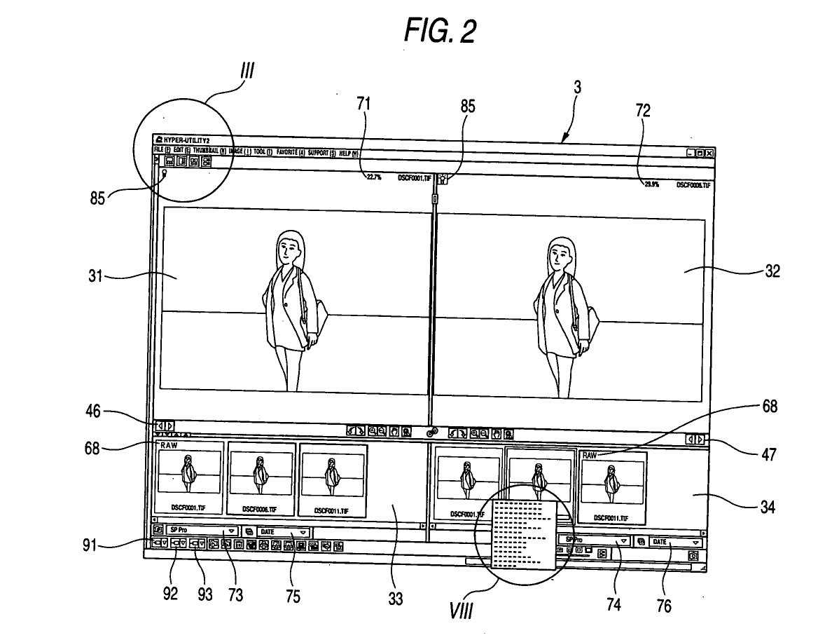

FIG. 2 is a screen layout diagram which is displayed on the monitor screen 3 as a result of the CPU 11 executing the image comparative display program of the present embodiment. In more detail, the screen layout diagram is displayed in accordance with a display control signal from the display control section 20, in which the display control signal is generated in accordance with a result obtained by executing the image comparative display program in the CPU 11 based on user's instructions from the input device. The display control section 20 is primarily constituted of a processor that performs the function of controlling a screen display on the monitor screen 3. For example, but not by way of limitation, display control section 20 that performs the foregoing functions can be a general purpose computer containing a set of instructions for the below-described method of the present invention. As such, the display control section 20 may also include a computer-readable medium or a data carrier that contains instructions for performing the method of the present invention.

The monitor screen 3 is roughly split into four regions; that is, a region 31, a region 32, a region 33, and a region 34. One of images to be compared is displayed in the upper left first region 31. The other image which is also an object of comparison is displayed in the upper right second region 32.

Thumbnail images of respective images—which are stored in the folder and can be displayed as larger images in the first region 31—are displayed in the third region 33 located below the first region 31. Thumbnail images of respective images—which are stored in the folder and can be displayed as larger images in the second region 32—are displayed in the third region 34 located below the second region 32.

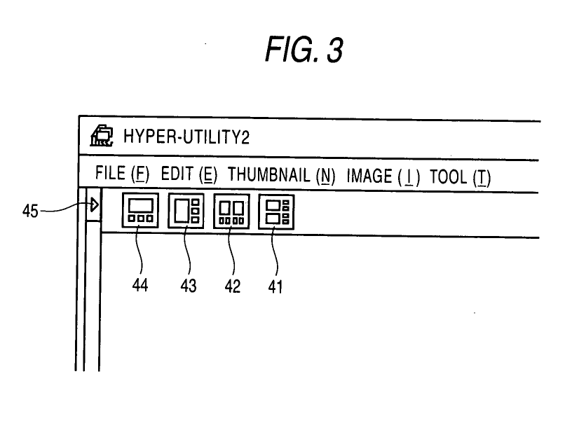

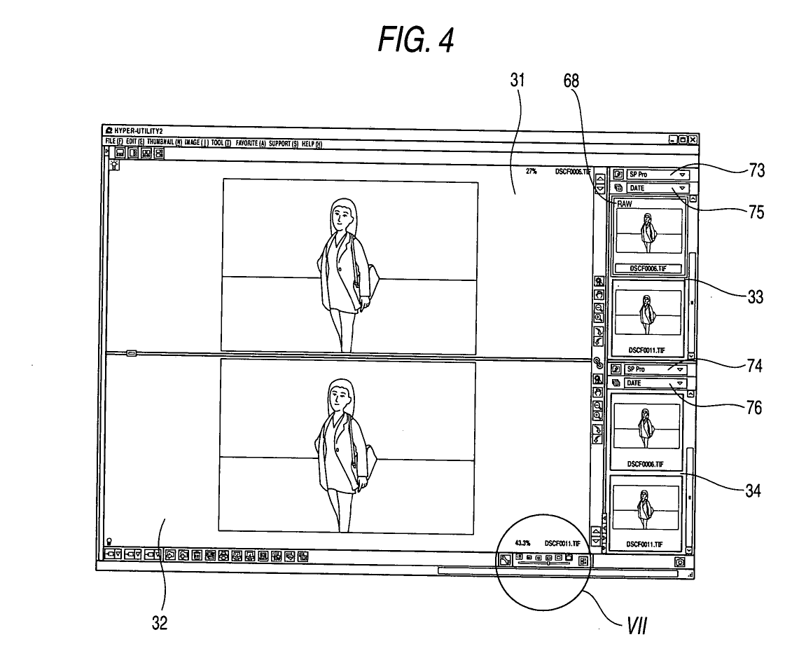

As can be seen from enlarged views shown in FIG. 3, screen layout command buttons 41, 42, 43, and 44 are displayed in an upper left corner of the monitor screen 3. In the screen layout shown in FIG. 2, the first region 31 and the second region 32 are arranged horizontally. The respective thumbnail image regions 33, 34 are provided below the first and second regions 31, 32. The command button 41 shown in FIG. 3 is highlighted with a mouse cursor and then clicked, whereby the screen shown in FIG. 2 is changed to the screen shown in FIG. 4.

Specifically, the first region 31 and the second region 32 are arranged vertically in FIG. 4. The thumbnail display regions 33, 34 are provided on the right of the first and second regions 31, 32, respectively. When the screen layout command button 42 is clicked on the screen shown in FIG. 4, the display returns to the screen layout shown in FIG. 2.

When the screen layout command button 44 shown in FIG. 3 is clicked, one image is displayed on the monitor screen 3, and thumbnail images of selectable images are displayed below the image. Similarly, when the screen layout command button 43 is clicked, one image is displayed on the monitor screen 3, and thumbnail images of selectable images are displayed on the right of the image. A triangular button 45 provided on the left end of the screen will be described later.

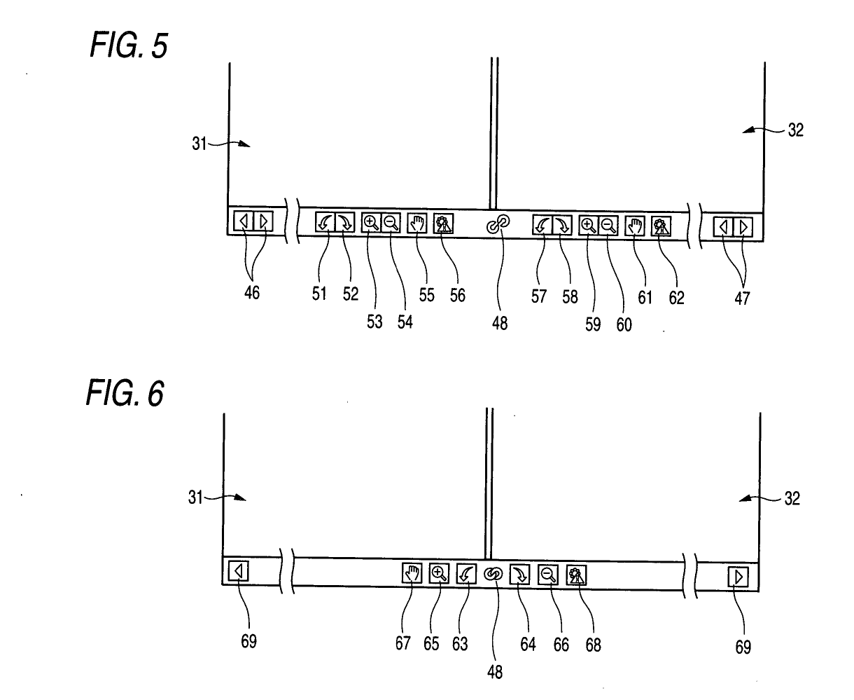

In the screen layout shown in FIG. 2, as can be seen from an enlarged view shown in FIG. 5, operation buttons assigned to the image displayed in the first region 31 and those assigned to the image displayed in the second region 32 are provided in an area extending from the lower end of the first region 31 to the lower end of the second region 32.

In FIG. 5, a display region shift operation button 46 is provided at the left corner for horizontally scrolling the image displayed in the first region 31 (in a lateral direction). A display area shift operation button 47 is provided at the right corner for horizontally scrolling the image displayed in the second region 32. An operation button to be used for scrolling the displayed image vertically (in the longitudinal direction) is not displayed in the embodiment. If the entire image cannot be viewed without scrolling the image vertically, an operation button to be used for vertical scroll operation is displayed.

A sync button 48 is provided at the center. Disposed to the left of the sync button 48 are various operation buttons assigned to the image displayed in the first region 31; namely, a left rotation button 51, a right rotation button 52, an enlargement button 53, a reduction button 54, a shift button 55 for shifting an image while gripping the same; and a color area warning display button 56 assigned to the displayed image. Disposed to the right of the sync button 48 are various operation buttons assigned to the image displayed in the second region 32; namely, a left rotation button 57, a right rotation button 58, an enlargement button 59, a reduction button 60, a shift button 61 for shifting an image while gripping the same; and a color area warning display button 62 assigned to the displayed image. In the state shown in FIG. 4, these operation buttons are provided in line in the vertical direction as illustrated.

As mentioned above, the operation buttons assigned to the image displayed in the first region 31 and the operation buttons assigned to the image displayed in the second region 32 are provided separately so as to correspond to the respective regions 31, 32. Therefore, the user can readily ascertain which of the images are assigned to the operation buttons now being operated.

The color area warning display button 62 provided in the present embodiment is a button to be used for explicitly displaying a defective portion of the displayed image when the defective portion is present in the image. The defective portion includes, e.g., a portion which has become whitened because of excessively high brightness or a portion which has become solid black because of excessively low brightness. When the button 62 is clicked, a defective portion of the displayed image is displayed while being filled in, e.g., red. As a result, the user can readily ascertain a location of the defective portion.

When the sync button 48 is clicked, the image displayed in the first region 31 and the image displayed in the second region 32 are operated synchronously. Specifically, when the image displayed in the first region 31 is enlarged, the image displayed in the second region 32 is also enlarged at the same magnification. When the image displayed in the second region 32 is scrolled, the image displayed in the first region 31 is also scrolled in the same direction and over the same travel distance. When the sync button 48 is clicked once again, the sync state is canceled, whereby the images return to an asynchronous state.

In a sync state, both images are synchronously subjected to rotation, enlargement, reduction, movement, and color area warning display by means of actuation of any one of the operation buttons provided on either the right or left side. However, integrating the operations buttons into a single button rather than the operation buttons being displayed in the respective display regions 31, 32 can be said to be preferable, because the user can intuitively ascertain a sync state.

FIG. 6 is a view showing the operation buttons which are integrated in a sync state. In the present embodiment, the shape of the sync button 48 differs from a clicked state, or a sync state, to an asynchronous state. As shown in FIG. 5, in the asynchronous state two half-moon-shaped sections are separated from each other. As shown in FIG. 6, in the sync state the two half-moon-shaped sections overlap each other. From the shape of the sync button 48, the user can readily ascertain whether or not the images are in the sync state.

In addition to the change in the shape of the sync button 48, the operation buttons are displayed in an integrated manner when the images are in the sync state in the present embodiment. Specifically, as shown in FIG. 6, an integrated single left rotation button 63, an integrated single right rotation button 64, an integrated single enlargement button 65, an integrated single reduction button 66, an integrated single shift button 67 for shifting an image while gripping the same, and an integrated single color area warning display button 68 assigned to the displayed image are provided, and an integrated single operation button 69 is also provided. Alternatively, either the set of buttons 51 to 56 or the set of buttons 57 to 62 may be deleted for integration.

When the two displayed images are synchronously subjected to enlargement/reduction operation by means of clicking the sync button 48, the images are enlarged or reduced at the same magnification after having entered a sync state. However, when the images have been displayed at different magnifications before clicking of the sync button 48, the displayed images are synchronously enlarged or reduced at different magnifications.

For instance, when the images of different sizes are compared with each other, there may be a case where the images are desired to be synchronously subjected to enlargement or reduction after having been adjusted such that persons shown in the images become identical in size with each other. In this case, for instance, an operation is performed such that the image displayed in the first region 31 is displayed at a magnification of about 33%. An operation is performed such that the image displayed in the second region 32 is displayed at a magnification of about 10%. Thus, adjustment isperformed in an asynchronous state such that the images of the persons in the two images become equal in size to each other, and the sync button 48 is clicked. As a result, the images of the persons are subjected to enlargement, reduction, and scrolling while maintaining the same size in the first and second regions 31, 32. At this time, scaling factors 71, 72 of the two images are displayed in predetermined portions of the first and second regions 31, 32, whereby the user can readily ascertain the magnifications of the respective images.

A layout of the thumbnail images 33, 34 will now be described. Thumbnail images of respective images, which are stored in the folder and can be displayed in the first region 31, are displayed in the thumbnail display region 33 shown in FIG. 2. Thumbnail images of the respective images, which are stored in the folder and can be displayed in the second region 32, are displayed in the thumbnail display region 34.

Folder name display windows 73, 74 are provided at positions below the respective regions 33, 34. Windows 75, 76 for display operation purpose are provided below the folder name display windows 73, 74 for displaying a criterion for sorting the images stored in each folder. The illustrated embodiment shows that the images stored in the folder are sorted according to a photographing date, and thumbnail images are displayed in the regions 33, 34 according to corresponding sorting sequences.

In the embodiment, sorting of the thumbnail images is performed separately for the respective first and second regions 31, 32. Even when the same folder is selected for the first and second regions 31, 32, a sorting sequence can be designated separately. Specifically, the thumbnail images sorted according to a file name are displayed in the thumbnail display region 33 corresponding to the first region 31, and the thumbnail images sorted according to a photographing date are displayed in the thumbnail display region 34 corresponding to the second region 32.

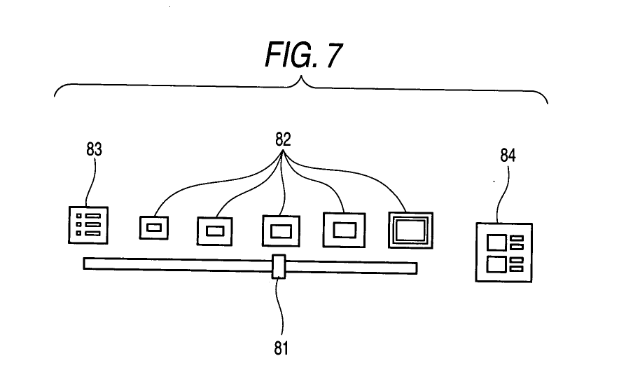

FIG. 7 is a view showing operation buttons of the thumbnail image. FIG. 7 is an enlarged view of an area encircled by a circle VII shown in FIG. 4.

Provided as operation buttons for thumbnail images are a slider 81 for continuously specifying the sizes of thumbnail images; command buttons 82 for specifying the size of the thumbnail image to a predetermined size; a file name display command button 83; and a photographing parameter display command button 84. As a result of the slider 81 being moved to a desired position, a thumbnail image whose size is in conformance to the position of the slider is displayed. As a result of any one of the buttons 82 having been clicked, a thumbnail image conforming to the size designated by the button is displayed.

When a list of file names stored in the folder is desired to be displayed in the third and fourth regions 33, 34 without displaying thumbnail images, the button 83 is clicked. Thereby, minute thumbnail images are displayed as icons in the form of a list along with the file names.

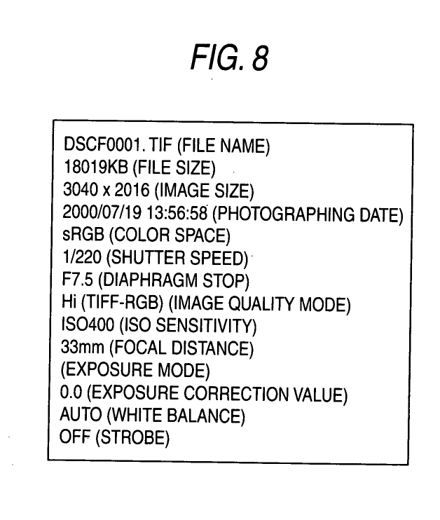

When the mouse cursor has been moved to any one of the thumbnail images and the image has been clicked, the image is selected. The thus-selected image is displayed in the corresponding region 31 (32). As mentioned above, according to the present embodiment, the overviews of the images desired to be displayed in the first and second regions 31, 32 can be ascertained beforehand in the form of thumbnail images. Hence, selection of images is facilitated. When the image has been selected and the button 84 shown in FIG. 7 has been further clicked, photographing parameters pertaining to the image are displayed as shown in FIG. 8. FIG. 8 is an enlarged view of the area encircled by circle VIII shown in FIG. 2.

In the embodiment, the operation buttons pertaining to the thumbnail images are provided as a common to the third and fourth regions 33, 34. A thumbnail image operation button customized to the third region 33 and another thumbnail image operation button customized to the fourth region 34 may be provided separately.

A thumbnail image stored in the third region 33 is selected and displayed in the first region 31. Another image—which is to be displayed in the second region 32 and which is an object of comparison—is changed while the image displayed in the third region is enlarged or reduced and a desired portion of the image is displayed by means of having performed scroll operation. In such a case, the image displayed in the second region 32 is displayed at the scroll position and at a magnification determined by a default. If, at this time, the image displayed in the first region 31 has been simultaneously replaced with the scroll position at the magnification determined by the default, there will arise a labor required again to return the image to the scroll position at a desired magnification.

Even when the other displayed image is changed to another image, leaving the other displayed image unchanged is preferable. As a result, a troublesome operation does not arise. When the displayed image has been changed to another image, this image may be displayed in a corresponding region after having been adjusted to assume the same magnification and scroll position as those of the unchanged displayed image.

In the embodiment shown in FIGS. 2 and 4, when the image data are not of a JPEG format, a TIFF format, or a bit map format but are image data (usually called “RAW data”) which are output directly from the solid-state imaging element, such as a CCD, RAW 68 is displayed at the upper left corner of the thumbnail image. As a result, the user can immediately ascertain that the image data are RAW data without displaying the photographing parameters pertaining to the thumbnail image shown in FIG. 8.

A photographer who is generally called a professional saves the image data photographed by the digital still camera as RAW data. The RAW data are subjected to image processing by means of a personal computer or the like. An image having a desired hue is generated while being compared by means of the image comparative display method of the present embodiment. However, if it is possible to ascertain, in a thumbnail image stage, whether the image data are unprocessed RAW data or processed image data of a TIFF format, a JPEG format, or the like, very useful information can be offered to the user.

There are usually a plurality of images. When a favorite image has been found in the images, a bookmark is affixed to an image file so that the image can be readily distinguished from the other images. However, affixing a bookmark to the file is insufficient for the user to immediately ascertain a correspondence to the image. For this reason, in the present embodiment, although omitted from the drawings, the bookmark is displayed as a small mark image like a tag. The favorite image is displayed by means of affixing the tag to the thumbnail image. As a result, when the thumbnail image is displayed, the user can immediately know whether or not the thumbnail image is selected as a favorite image by means of presence/absence of the tag.

If a plurality of types of bookmarks of different colors are prepared as tags, various ways of usage become feasible. For instance, images affixed with red tags are printed by one at a time, and images affixed with blue tags are printed by two at a time. Moreover, extraction of only images affixed with both red and green tags from the plurality of images also becomes easy. As a matter of course, affixed tags can be removed, and an operation button to be used for that purpose is also provided. However, the button is omitted from the drawings.

In the present embodiment, there are three types of tags; that is, red tags, green tags, and blue tags, are prepared. The image displayed in the first region 31 or a corresponding image in the thumbnail images is clicked, and a red tag selection button 91 provided at the lower left corner of the screen is clicked. The image is then affixed with a red tag. When a green tag selection button 92 is clicked, the image is affixed with a green tag. When a blue tag selection button 93 is clicked, the image is affixed with the blue tag.

As mentioned, the folder name whose thumbnail image is displayed is displayed in the folder name display windows 73, 74 shown in FIGS. 2 and 4. The thumbnail images of the images provided in this folder are displayed in the thumbnail image display regions 33, 34. When this folder is desired to be moved to another folder, an arrow button provided at the right corner of the folder name display windows 73, 74 is clicked, whereupon a list of selectable folder names is displayed. Therefore, the only requirement is to select a desired folder name from the list.

However, if the folder structure in the computer is unknown, there may be a case where difficulty is encountered in selecting a folder containing an image desired to be selected. For this reason, the button 45 shown in FIG. 3 is provided in the present embodiment.

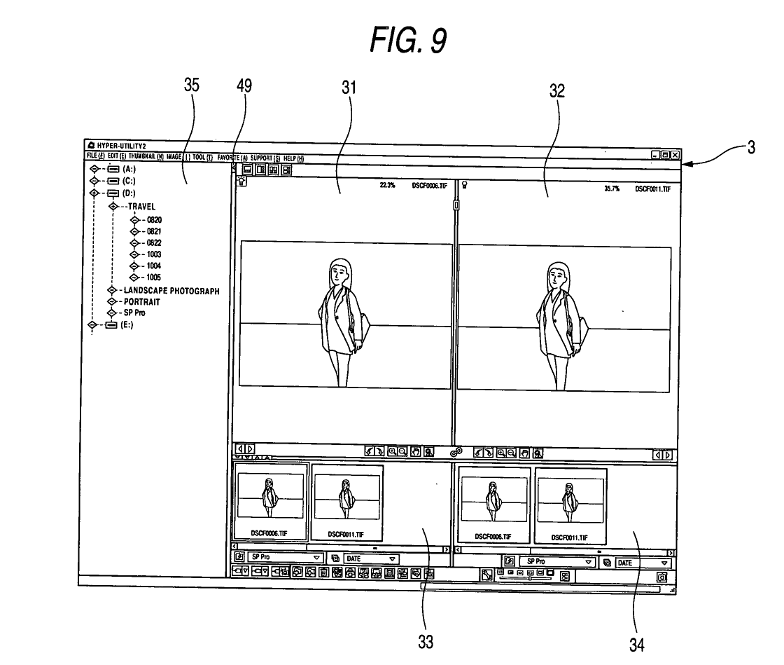

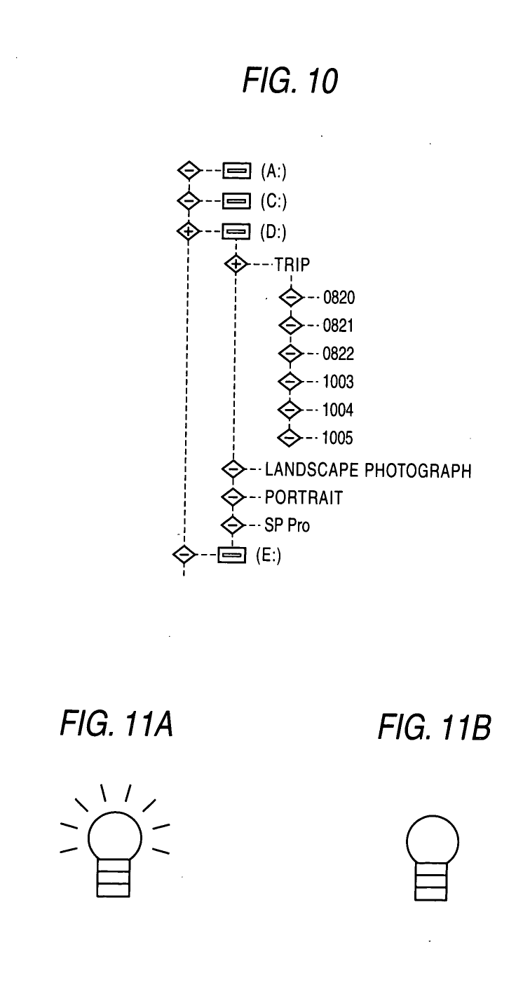

When the button 45 is clicked, a fifth region 35 is opened in the left region of the screen as shown in FIG. 9, whereby the monitor screen 3 is split into five regions 31 to 35. As can be seen from an enlargement shown in FIG. 10, a folder structure in the computer is displayed as a tree structure in the fifth region 35.

By means of glancing at the tree structure, the user clicks a “trip” folder prepared by himself/herself. The user further clicks a 0820 folder, whereby images photographed on August 20^{th} can be displayed in the first and third regions 31, 33.

When a folder has been selected by means of the tree structure, a folder whose image is to be displayed in the first region 31 is selected by means of the tree structure displayed on the left. A folder whose image is to be displayed in the second region 32 can also be selected by means of the tree structure opened on the right of the screen. However, when a sixth region for displaying a tree structure is opened on the right of the screen 3 in addition to the fifth region 35 for displaying the tree structure, the areas of the regions 31, 32, 33, and 34, where images are to be displayed, become smaller, thereby rendering displayed images smaller and posing difficulty in viewing the displayed images.

In the embodiment, the tree structure displayed on the fifth region 35 is shared between the first region 31 and the second region 32. Hence, small marks, e.g., lamp image 85 of the embodiment, are displayed in the respective left corners of the first and second regions 31,32. In the present embodiment, the lamp image 85 is displayed, and the tree structure for the first region 31 and the tree structure for the second region 32 are distinguished from each other by means of an illuminated image (FIG. 11A) of the lamp 85 and an unilluminated image (FIG. 11B) of the lamp 85.

When any area in the first region 31 is clicked, the lamp image 85 of the first region 31 is changed to the illuminated image shown in FIG. 11A, and the lamp image 85 of the second region 32 is changed to the unilluminated image shown in FIG. 11B. When a folder in the tree structure is designated in this state, the folder is selected as a folder whose images are displayed in the first region 31. Similarly, when any area in the second region 32 is clicked, the display of the lamp 85 is inverted. When a folder in the tree structure is designated, images in the folder are displayed in the second region 32.

Similarly, the selected regions 31, 32 are indicated in a distinguishable manner by the small lamp images 85. As a result, the right and left regions 31, 32 can be displayed in substantially the same manner, and occurrence of a problem of the images displayed in the regions 31, 32 being viewed differently can be prevented by means of the lamp image 85.

For instance, a color bar is displayed at an upper portion of the first region 31 in place of the small lamp image 85, thereby indicating that the first region 31 has already been selected. By means of this configuration, even when totally identical images are displayed in the first and second regions 31, 32, respectively, the image displayed in the first region 31 provided with the color bar is viewed slightly different from the image displayed in the second region 32 not having any color bar. This difference in the way of view poses a bigger problem for specialists in images. In order to eliminate this influence, the small lamp image 85 is adopted in the present embodiment.

For the same reasons, in the present embodiment, color operation buttons or the like are not provided around the first and second regions 31, 32 where images are to be displayed, to thereby render the surroundings of the first and second regions as achromatic as possible. The symmetric layout is employed such that surroundings of both first and second regions become identical with each other. As a matter of course, the layout is determined so as to be vertically symmetrical in the state shown in FIG. 4.

When the fifth region 35 is opened, the a left-oriented triangular button 49 appears in the topmost position in the boundary between the fifth region 35 and the first region 31. Hence, the fifth region 35 is closed by means of clicking the button 49, and a state shown in FIG. 2 is achieved.

The present invention facilitates selection of images to be compared and enables rendering of an easy determination as to whether or not sync operation is performed.

The image comparative display method of the present invention facilitates an operation for selecting images to be displayed side by side, and presence/absence of synch operation can be readily determined. hence, the method is useful as image processing application software.

This application is based on Japanese patent application JP 2003-321043, filed on Sep. 12, 2003, the entire content of which is hereby incorporated by reference, the same as if set forth at length.

1. A method of comparatively displaying a first image and second image, comprising:
displaying said first image and said second image on a user interface in a side-by-side arrangement, wherein the first image is selected from a first set of images and the second image is selected from a second set of images,
wherein the user interface includes a first region that displays the first image; a second region that displays the second image; a third region adjacent to the first region, the third region displaying at least one first thumbnail image corresponding to at least one image from the first set of images; and a fourth region adjacent to the second region, the fourth region displaying at least one second thumbnail image corresponding to at least one image from the second set of images.

2. The method according to claim 1, further comprising:
using at least one first operation button displayed outside a first image display frame of the first region to perform at least one operation on the first image;
using at least one second operation button displayed outside a second image display frame of the second region to perform at least one operation on the second image, the second operation button being different from the first operation button; and
via a sync button positioned between said at least one first operation button and said at least one second operation button, setting the first and second images to operate synchronously, and canceling the setting.

3. The method according to claim 2, further comprising displaying said at least one first operation button and said at least one second operation button in an integrated manner when, as a result of said setting, the first and second images operate synchronously.

4. The method according to claim 2, wherein each of said at least one first operation button and said at least one second operation button includes at least one of an enlargement/reduction operation button, a display region shift operation button, a display image rotating operation button, and a display image color area warning display operation button.

5. The method according to claim 1, wherein the user interface displays a command button to be used for switching a screen display by selecting one of a first screen layout and a second screen layout,
wherein the first screen layout comprises the first and second regions being arranged horizontally on the user interface, the third region being arranged below the first region, and the fourth region being arranged below the second region, and
the second screen layout comprises the first and second regions being arranged vertically on the use interface, the third region being arranged on the right of the first region, and the fourth region being arranged on the right of the second region.

6. The method according to claim 1, further comprising displaying a magnification of the first image in the first region and a magnification of the second image in the second region.

7. The method according to claim 1, wherein, a display status of the second image displayed in the second region is not changed when the first image is changed to another first image by selecting and displaying one of said at least one first thumbnail image in the third region.

8. The method according to claim 1, wherein, when an operation is performed while the user interface includes the first region, the second region, the third region and the fourth region, a fifth region is opened in the user interface and a tree structure of folders is displayed in the fifth region.

9. The method according to claim 8, wherein, when another operation is performed while the user interface includes the first region, the second region, the third region, the fourth region, and the fifth region, the fifth region is closed.

10. The method according to claim 5, further comprising:
when a first folder is selected from the tree structure while selecting the first region, displaying said at least one first thumbnail image corresponding to at least one image included in the first folder in the third region; and
when a second folder is selected from the tree structure while selecting the second region, displaying said at least second thumbnail image corresponding to at least one image included in the second folder in the fourth region, wherein the first and second folders are one of same and different.

11. The method according to claim 10, wherein a first mark representing a selected first region state and a second mark representing a selected second region state are displayed in a first region corner and a second region corner, respectively.

12. The method according to claim 1,
wherein, when at least one bookmark is affixed to at least one of the first image and second images, at least one thumbnail image corresponding to at least one of the bookmarked first and second images is displayed and affixed with a mark image representing the bookmark in at least one of (i) said at least one first thumbnail image displayed in the third region and (ii) said at least one second thumbnail image displayed in the fourth region.

13. The method according to claim 12, wherein said at least one bookmark comprises a plurality of types of bookmarks, and a corresponding plurality of mark images, each of which represents each of said plurality of types of bookmarks, are displayed in colors according to the types of the plurality of bookmarks.

14. The method according to claim 1, further comprising, when at least one of (i) said at least one first thumbnail image and (ii) said at least one second thumbnail image is displayed, displaying at least one RAW thumbnail image corresponding to a RAW data image and affixing said at least one RAW thumbnail image with a RAW data indicator.

15. The method according to claim 1, wherein a first operation button configured to to change a display size of said at least one first thumbnail image and a second operation button configured to change a display size of said at least one second thumbnail image are displayed outside respective image display frames of the third and fourth display regions.

16. The method according to claim 1, wherein a first operation window configured to change a sequence in which said first thumbnail images are to be sorted and a second operation window configured to change a sequence in which said second thumbnail images are to be sorted are displayed outside of image display frames of the third and fourth regions, respectively.

17. A computer-readable medium including set of instructions for comparatively displaying a plurality of images, said set of instructions comprising:
dividing a user interface into a first region that displays a first image; a second region that displays a second image; a third region adjacent to the first region, the third region displaying at least one first thumbnail image corresponding to at least one image from a first set of images; and a fourth region adjacent to the second region, the fourth region displaying at least one second thumbnail image corresponding to at least one image from a second set of images; and
displaying the first image and the second image, on a user interface in a side-by-side arrangement, wherein the first image is selected from the first set of images and the second image is selected from the second set of images.

18. A comparative image display apparatus comprising:
a display device comprising a user interface;
a display control section that controls a screen display on the monitor screen by executing said set of instructions in the computer-readable medium, said instructions comprising,
dividing the user interface into a first region that displays a first image; a second region that displays a second image; a third region adjacent to the first region, the third region displaying at least one first thumbnail image corresponding to at least one image from a first set of images; and a fourth region adjacent to the second region, the fourth region displaying at least one second thumbnail image corresponding to at least one image from a second set of images
displaying the first image and the second image, on a user interface in a side-by-side arrangement, wherein the first image is selected from the first set of images and the second image is selected from the second set of images; and
an input device by way of which a plurality of operation buttons displayed on the user interface are operated.

19. A comparative image display apparatus comprising:
a display device comprising a user interface;
means for controlling a screen display on the monitor screen by executing said set of instructions in the computer-readable medium, said instructions comprising,
dividing the user interface into a first region that displays a first image; a second region that displays a second image; a third region adjacent to the first region, the third region displaying at least one first thumbnail image corresponding to at least one image from a first set of images; and a fourth region adjacent to the second region, the fourth region displaying at least one second thumbnail image corresponding to at least one image from a second set of images; and
displaying the first image and the second image, on a user interface in a side-by-side arrangement, wherein the first image is selected from the first set of images and the second image is selected from the second set of images; and
means for operating a plurality of operation buttons displayed on the monitor screen.
